(19) United States
(12) Patent Application Publication
(10) Pub. No.: US 2025/0034675 A1
(43) Pub. Date: Jan. 30, 2025

(54) METHOD OF MANUFACTURING INORGANIC ION EXCHANGER FOR SELECTIVE EXTRACTION OF LITHIUM FROM LITHIUM-CONTAINING NATURAL AND TECHNOLOGICAL BRINES

(71) Applicants: PAVEL KUDRYAVTSEV, Rehovot, IL (US); Nikolai Kudriavtsev, Holon, IL (US)

(72) Inventors: PAVEL KUDRYAVTSEV, Rehovot, IL (US); Nikolai Kudriavtsev, Holon, IL (US)

(21) Appl. No.: 18/225,373

(22) Filed: Jul. 24, 2023

(51) Int. Cl. C22B 3/42; B01J 39/02; B01J 39/10; C22B 26/12

(52) U.S. Cl. CPC C22B 3/42; B01J 39/02; B01J 39/10; C22B 26/12

(57) ABSTRACT

A method of manufacturing an inorganic ion exchanger for the selective extraction of lithium from lithium-containing natural and technological brines is performed by interacting at least one soluble niobium(V) compound with an acid that contains at least one iron(III) compound, thus forming an electrolyte that contains a hydrated niobium(V) oxide and a hydrated iron(III) oxide, which co-precipitate and form a precipitate of a mixed hydrated niobium(V) and iron(III) oxide. The precipitate is washed, an excess of the electrolyte is removed, and the product is granulated with subsequent conversion into a lithium form, which is calcined and is converted to an H-form of the inorganic ion exchanger by treating thereof with an acid solution. the addition of Fe³⁺ ions contained in the iron(III) compound to the sorbent composition allows obtaining inorganic ion-exchange sorbents with a specific structure, which provides high selectivity, especially for lithium ions.

### FIELD OF THE INVENTION

The invention relates to the field of chemical technology and hydrometallurgy, in particular, to production of selective inorganic ion exchangers for extraction of lithium from lithium-containing natural and technological brines. The invention may find use in extracting lithium from neutral and slightly alkaline lithium-containing solutions with a high content of sodium ions and ions of other alkali and alkaline earth metals. More specifically, the invention relates to a technology for recovering lithium in the presence of oxidizing or reducing agents and under conditions of increased radiation. The method is based on the processes of preparation and use of ion sieves.

### DESCRIPTION OF THE PRIOR ART

Lithium has historically been obtained from two different sources—continental brines and hard rock minerals. Currently, lithium is used in producing glass, ceramics, medical substances, metallurgical products, lithium batteries, and in areas such as nuclear energy, aviation, etc. Global sales of lithium salts are worth more than a billion a year, and the demand for lithium will continue to grow because lithium is an indispensable component of the lithium-ion batteries that are now used as power sources for everything from smartphones and power tools to electric vehicles.

Lithium demand is forecast to grow by more than 300% in the coming years. Moreover, electric companies are expanding solar energy production and experiencing a need for lithium-ion batteries of high storage density. The acute dependence of many global industries on lithium has led to a global search for new sources of lithium.

Currently, hydromineral raw materials are gradually becoming the main source of lithium. At the same time, in world practice, the main attention is paid to developing methods for processing lithium-containing hydromineral raw materials. Nowadays, a method that is most often used in practice to extract lithium is the precipitation of sparingly soluble salts from natural brines. From the ecological point of view, however, the most advantageous are methods of extracting lithium by sorption from lithium-poor natural and technological brines. More so, these sources contain the main world reserves of lithium. Due to the complexity of the salts contained in the composition of hydromineral raw materials, highly selective inorganic ion-exchange materials become most promising for realizing the above methods.

Some inventions illustrating the state of the art of extracting lithium using lithium-selective inorganic ion-exchange materials are shown below.

Chinese Patent Application Publication CN101944600A published on Jan. 12, 2011 (Inventors: Xichang Shi, et al.), discloses an ion sieve adsorbent for extraction of lithium ions based on lithium-titanium oxide and a method for preparing a precursor for this ion sieve adsorbent suitable for adsorbing enriched lithium from salt-lake brines, seawater, and other liquid lithium-containing resources. The method consists of using titanium dioxide and lithium salt as raw materials, grinding the raw material in a ball grinder, and drying the ground product for preparing lithium titanate as the precursor through a high-temperature solid-phase roasting process. The lithium is then eluted from the precursor (Li₂TiO₃) by inorganic acid to prepare an ion sieve H₂TiO₃.

According to a preferred embodiment, the process is based on a molar ratio of lithium to titanium of 2:1; anhydrous ethanol or acetone is used as a dispersion medium; grinding is carried out in a ball mill from 2 to 3 hours; the grounded product is calcined at 800° C. for 12 hours; and, as a result, a lithium Li₂TiO₃ adsorbent is obtained.

U.S. Pat. No. 8,901,032, issued on Dec. 2, 2014, to Stephen Harrison, et al., discloses a method for producing a porous adsorbent based on activated alumina for lithium extraction. The method is carried out by contacting three-dimensional activated alumina with a lithium salt under conditions sufficient to infuse lithium salts into activated alumina for the selective extraction and recovery of lithium from lithium-containing brines. A lithium intercalated sorbent based on an activated alumina provides a controlled and maximum permissible lithium to aluminum ratio and a favorably structurally shaped and dispersed composition, thereby increasing throughput for extracting lithium. In certain embodiments, the lithium intercalated sorbent based on activated alumina has a molar fraction ratio of lithium to aluminum in the range of about 0.1 to 0.3 and preferably up to about 0.33. The ratio of lithium to alumina is critical in stabilizing the structural form of the material and maximizing the number of lithium sites available in the matrix for loading and unloading lithium from the brine solution.

International Patent Application Publication No. WO2003041857 A1, published on May 22, 2003 (Inventor: Alexander Ryabstsev, et al.), relates to a method for producing granulated sorbents in the form of a double hydroxide of aluminum and lithium in a waste-free solid phase of aluminum hydroxide and lithium salts in a mixer, with subsequent continuous activation of crystalline DHAL-Cl in a centrifugal mill activator to obtain a defective crystalline structure. The obtained product is mixed with chlorinated polyvinyl chloride as a binding agent and liquid methylene chloride. The granulated sorbent is suitable for selective lithium extraction from chloride salt minerals with an extraction degree of 95 at. %.

Also known as Russian Patent No. 1524253, issued on Feb. 15, 1994, to Melikhov, et al. This patent relates to ion exchange removal of lithium from solutions. The method includes the steps of passing the solutions through a sorption material consisting of a sorbent selective to lithium and based on manganese oxides or manganese and aluminum oxides in a hydrogen form and an auxiliary sorbent in a salt form, followed by their regeneration, respectively, with a solution of nitric acid and alkaline solution. The method is characterized in that, to increase a degree of lithium recovery from the natural and technological brines, as well as a degree of regeneration of the auxiliary sorbent and the reduction of the regeneration time, the sorbent is one selective to lithium in an alkaline medium based on titanium hydroxide, the transmission is conducted through alternating layers of selective and auxiliary sorbents, and regeneration of an auxiliary sorbent is carried out with the original lithium solution at pH 12-13. A hydrated titanium dioxide or a mixed hydroxide of titanium and iron is used as the auxiliary sorbent. A disadvantage of this method is that the obtained sorbent has low stability in the presence of oxidants or reducing agents.

U.S. Pat. No. 7,943,113, May 17, 2011, issued to Chung; Kang-Sup, et al., discloses a method for preparing lithium-manganese oxides, the method comprising: mixing a lithium raw material, a manganese raw material, and a metal raw material—the manufacturing mixture material is expressed by the following chemical formula: Li₁₊ₓMn_{1-xy}M_{y}O_{2+z}, wherein 0.01≤x≤0.5, 0≤y≤0.3, −0.2≤z≤0.2, and M is a metal selected from the group consisting of Mn, V, Cr, Co, Ni, Cu, Zn, Zr, Nb, Mo, W, Ag, Sn, Ge, Si, Al, of an alloy thereof, and wherein the lithium-manganese oxides have a layered structure. The mixture is heat treated under a reduction atmosphere.

U.S. Pat. No. 8,926,874, Jan. 6, 2015 (Chung; Kang-Sup et al.) discloses a porous manganese oxide sorbent for lithium having spinel-type structure and a method of manufacturing the same. This invention relates to a porous manganese oxide-based lithium sorbent and a method for preparing the same. The method includes the steps of preparing a mixture by mixing a reactant for the synthesis of a lithium-manganese oxide precursor powder with an inorganic binder, molding the mixture, preparing a porous lithium-manganese oxide precursor molded body by heat-treating the molded mixture, and acid-treating the porous lithium-manganese oxide precursor molded body such that lithium ions of the porous lithium-manganese oxide precursor are exchanged with hydrogen ions, wherein pores are formed in the lithium-manganese oxide precursor molded body by gas generated in the heat treatment. The method comprises the steps of preparing a lithium-manganese oxide precursor molded body by preparing a mixture by adding an additive comprising at least one selected from the group consisting of carbon powder, carbon nanotubes (CNT), polyethylene (PE), and polypropylene (PP) to a lithium-manganese oxide precursor reactant, adding water glass to the mixture. Heat-treating the resulting mixture, wherein the water glass is added in an amount of 10 to 60 parts by weight concerning 100 parts by weight of the mixture. Acid-treating the lithium-manganese oxide precursor molded body, wherein in the heat treatment, pores are formed in the lithium-manganese oxide precursor molded body by gas generated by decomposition of the lithium manganese oxide precursor reactant or the water glass.

International Patent Application Publication No WO 2011058841, Application priority: May 22, 2003 (inventor—Yoshizuka). This application describes a method for producing raw materials for a lithium adsorbent and concentrating lithium. Also described is an apparatus for concentrating lithium. This method comprises a mechanochemical step of mixing trimanganese tetraoxide and lithium hydroxide such that the molar ratio of manganese (x) and lithium (y) is x:y=1:1 to 1.5:1, and subjecting the mixture to mechanochemical pulverization; a pre-calcining step of pre-calcining the intermediate product at a temperature in the range of 375° C. to 450° C. in the air or an oxygen atmosphere; a step of calcining the obtained product with subsequent cooling, mixing, and pulverizing, followed by calcining the product in a temperature range of 475° C. to 550° C. in the air or an oxygen atmosphere to obtain a spinel-type lithium manganate with excess oxygen a step of eluting lithium by treating the spinel-type lithium manganate with excess oxygen using acid in an amount that is in significant excess for the amount of lithium.

U.S. Pat. No. 10,322,950 B2 issued on Jun. 18, 2019, to David Henry Snydacker, discloses a method for extracting lithium from solutions containing lithium ions via reversible cation exchange with H⁺ provided. The method utilizes metal oxide or metalloid oxide cation exchange materials having an active sublattice that preferentially bind Li⁺ cations, relative to both H⁺ and Na⁺, in a sample solution, and preferentially bind H⁺, relative to Li⁺, in an acidic solution.

U.S. Pat. No. 11,253,848 B2 issued on Feb. 22, 2022, to David Henry Snydacker, discloses a method for the extraction of lithium from liquid resources such as natural and synthetic brines, leachate solutions from minerals, and recycled products.

U.S. Pat. No. 10,434,497, issued on Oct. 8, 2019, to P. Kudryavtsev et al., a method of obtaining inorganic sorbents for extracting lithium from lithium-containing natural and technological brines. The method is carried out by contacting a soluble niobate (V) with an acid in the presence of at least one zirconium (IV) salt to obtain a precipitate of mixed hydrated niobium and zirconium oxide. Subsequent steps include granulating the precipitate by freezing, converting the granulation product into a Li-form, calcining the Li-form, and converting the obtained granulated mixed lithium, niobium, and zirconium oxide into an ion-exchanger in an H-form. The inorganic sorbent is ready for lithium extraction in the obtained H-form.

U.S. Pat. No. 11,179,715, issued to P. Kudryavtsev et al. on Nov. 23, 2021, relates to an Inorganic ion-exchanger for selective lithium extraction from lithium-containing natural and industrial brines. The inorganic ion exchanger is a non-stoichiometric compound as a polymeric aqua-oxo-hydroxo complex. It is intended for selective lithium extraction from lithium-containing natural and industrial brines. The following general formula represents the proposed ion-exchanger: HₐNbO_{(2.5+0.5-a)}·cZrO₂·dH₂O, wherein: “a” is a number ranging from 0.5 to 1.5, “c” is a number ranging from 0.01 to 1.0, “d” is a number ranging from 0.1 to 2.0. The inorganic ion exchanger is a polymeric aqua-oxo-hydroxo complex of niobium and zirconium in the form of solid particles.

U.S. Pat. No. 11,260,366, issued on Mar. 1, 2022, to P. Kudryavtsev et al., discloses a method of obtaining inorganic sorbents for lithium extraction from lithium-containing natural and technological brines. The method consists of steps of obtaining six consecutive non-stoichiometric compounds, wherein at the final step, the sixth non-stoichiometric compound is obtained by converting the fifth non-stoichiometric compound into a hydrogen-form of inorganic ion-exchanger by treating the fifth non-stoichiometric compound with an acid solution. The method improves the selectivity and exchangeability of sorbents to lithium-based on manganese oxides, as well as the chemical stability of the sorbents in cyclic operations.

U.S. patent application Ser. No. 17/688,005, filed on Mar. 7, 2022, by P. Kudryavtsev et al., discloses a method of manufacturing inorganic ion-exchanger for the selective extraction of lithium from lithium-containing natural and technological brines, the inorganic ion exchanger being represented by the following general formula:

HₐNbO_{(2.5+0.5-a)}·bLi₂O·cWO₃·dH₂O; wherein: “a” is a number ranging from 0.5 to 2.0, “b” is a number ranging from 0.01 to 0.5, “c” is a number ranging from 0.01 to 0.2, and “d” is a number ranging from 0.1 to 2.0, wherein the method comprising the following steps: interacting a soluble niobate (V) with an acid that contains at least one soluble tungsten (VI) compound, thus forming a hydrated niobium(V) oxide and a hydrated tungsten (VI) oxide, which co-precipitate and form a mixed hydrated niobium(V) and tungsten (VI) oxide; granulating the mixed hydrated niobium(V) and tungsten (VI) oxide by freezing with subsequent defreezing, thus obtaining a granulated mixed hydrated niobium(V) and tungsten (VI) oxide; converting the granulated mixed hydrated niobium(V) and tungsten (VI) oxide into a lithium form by treating thereof with a lithium-containing compound selected from the group consisting of aqueous solutions of lithium hydroxide and lithium carbonate; calcining the lithium form of the granulated mixed hydrated niobium(V) and tungsten (VI) oxide to obtain a mixed granulated tripled lithium, niobium(V) and tungsten (VI) oxide, which constitutes a lithium-form of the inorganic ion-exchanger; and converting the lithium-form of the inorganic ion-exchanger into an H-form of the inorganic ion-exchanger by treating thereof with an acid solution.

U.S. patent application Ser. No. 17/688,047, filed on Mar. 7, 2022, by P. Kudryavtsev et al., discloses an inorganic ion-exchanger in the form of solid particles comprising a chemical non-stoichiometric compound in the form of an inorganic polymeric aqua-oxo-hydroxo complex intended for selective extraction of lithium from lithium-containing natural and industrial brines, the inorganic ion-exchanger being represented by the following general formula: HₐNbO_{(2.5+0.5-a)}·bLi₂O·cWO₃·dH₂O; wherein: “a” is a number ranging from 0.5 to 2.0, “b” is a number ranging from 0.01 to 0.5, “c” is a number ranging from 0.01 to 0.2, and “d” is a number ranging from 0.1 to 2.0.

U.S. patent application Ser. No. 17/956,656, filed on Sep. 29, 2022, by P. Kudryavtsev et al., discloses a method for obtaining an inorganic sorbent for extraction of lithium from a lithium-containing brine, the method comprising:

contacting a mixture of at least one soluble manganese (II) salt in an aqueous solution and at least one aluminum (III) salt in an aqueous solution with an alkali solution in a reaction container in a mother solution in the presence of an alkali metal permanganate to obtain a precipitate of a mixed hydrated manganese (III), manganese (IV), and aluminum (III) oxide, which comprises a non-stoichiometric compound; washing the obtained precipitate by decanting with deionized water to a certain content in the mother solution of the at least one alkali metal salt; discontinuing the decanting and settling the precipitate in the reaction container to a predetermined level; removing a transparent part of the mother solution to obtain a precipitate suspension in a residue of the mother solution; transferring the obtained precipitate of the precipitate suspension in the residue of the mother solution to a freezer container and freezing the precipitate to a solid frozen state for obtaining a mixed hydrated manganese (III), manganese (IV), and aluminum (III) oxide in an icy granular form having a surface; removing at least one alkali metal salt from the surface of the icy granular form; thawing the mixed hydrated manganese (III), manganese (IV), and aluminum (III) oxide to form a resulting granulated mixed hydrated manganese (III), manganese (IV), and aluminum (III) oxide and thawing the mother solution to form a thawed mother solution; separating the icy granular form from an excess of the thawed mother solution; converting the resulting granulated mixed hydrated manganese (III), manganese (IV), and aluminum (III) oxide into an H-form of the granulated mixed hydrated manganese (III), manganese (IV), and aluminum (III) oxide by treating thereof with a solution of an acid; converting the H-form of the granulated mixed hydrated manganese (III), manganese (IV), and aluminum (III) oxide into a Li-form of the granulated mixed hydrated manganese (III), manganese (IV), and aluminum (III) oxide by treating thereof with a solution of a lithium-containing compound; drying and calcining the Li-form of the granulated mixed hydrated manganese (III), manganese (IV), and aluminum (III) oxide to obtain a dehydrated granulated mixed manganese (III), manganese (IV), and aluminum (III) oxide, which contains in its composition four oxides and comprises a lithium-form of an inorganic ion-exchanger; and converting the obtained lithium-form of an inorganic ion exchanger into an H-form of the ion-exchanger by treating thereof with an acid solution.

U.S. patent application Ser. No. 17/979,999, filed on Nov. 3, 2022, by P. Kudryavtsev, et al., describes an inorganic ion-exchanger in the form of solid particles comprising a chemical non-stoichiometric compound in the form of an inorganic polymeric aqua-oxo-hydroxo complex intended for selective extraction of lithium from lithium-containing natural and industrial brines, the inorganic ion-exchanger being represented by the following general formula: HₓMnO_{y}·zAl₂O₃·nH₂O; wherein: “x” is a number ranging from 0.5 to 2.0, “y” is a number ranging from 2.0 to 3.0, “z” is a number ranging from 0.01 to 0.1, and “n” is a number ranging from 1.0 to 2.0.

### BRIEF DESCRIPTION OF THE DRAWINGS

FIG. 1 is a graph illustrating a total exchange capacity of hydrated niobium pentoxide E_{Li} with additives of Fe³⁺ ions (sorption of lithium from 0.1 N Li₂CO₃ solution; Fe/Nb is a molar ratio of the Fe³⁺ additive to the total amount of the Nb⁵⁺ ions in the sorbent composition).

FIG. 2 is a graph that illustrates the effect of the solution pH on the total exchange capacity (EU, meq of Li per 1 g of sorbent) of hydrated niobium pentoxide (HNP) obtained by titrating a HNP sample without addition (Curve 1) and with an addition of Fe³⁺ (Curve 2), the titration being carried out with 0.1N solution of UOH (Ionic Strength I=0.1; Fe/Nb=0.108 is a molar ratio of the Fe³⁺ additive to the total amount of the Nb⁵⁺ ions in the sorbent composition).

FIG. 3 is a graph that shows a 3D dependence of the selective capacity for lithium (E_{Li}, mg of Li per 1 g of sorbent—numbers) on the heat treatment temperature of the Li-form of the sorbent; Fe/Nb is a molar ratio of the Fe³⁺ additive to the total amount of the Nb⁵⁺ ions in the sorbent composition.

FIG. 4 is a graph that shows an effect of the calcination temperature of materials on their sorption-selective properties during sorption from a model complex solution with a ratio Li/Na=1/10; Curve 1 shows E_{Li} capacity for lithium (meq of Li per 1 g of sorbent); Curve 2 shows E_{Na} capacity for sodium (meq of Li per 1 g of sorbent); and Curve 3 corresponds to Li/Na=E_{Li}/E_{Na}—molar ratio of Lit and Na⁺ ions in the sorbent phase after completion of the sorption process; the samples had a ratio Fe(III):Nb(V) equal to 0.07.

FIG. 5 is a graph that illustrates dependences of lithium capacity (E_{Li}; meq of Li per 1 g of sorbent), sodium capacity (E_{Na}; meq of Na per 1 g of sorbent), and E_{Li}/E_{Na} ratio in the solid phase of the sorbent during sorption from a model complex solution with Li/Na=1/10, on the content of iron(III) ions in the sorbent; Fe(ill):Nb(V) is an ion ratio in the sorbent, where the curve 1 corresponds to E_{Li}; the curve 2 corresponds to E_{Na}; and the curve 3 corresponds to Li/Na=E_{Li}/E_{Na}; the samples were calcined at t=420° C.

FIG. 6 shows losses of sorbents for one cycle of operation in the mode of sorption-desorption for samples with the addition of Fe³⁺ ions at the ratio of Fe(III) to Nb(V) equal to 0.07; samples corresponding to the curve plotted by dots 1 were calcined 400° C., samples corresponding to the curve plotted by dots 2 were calcined at 540° C.

### SUMMARY OF THE INVENTION

The invention relates to chemical technology and hydrometallurgy, particularly to the production of lithium-selective inorganic ion exchangers for lithium extraction from lithium-containing natural and technological brines. The invention may find use in extracting lithium from neutral and slightly alkaline solutions with a high content of sodium ions and ions of other alkali and alkaline earth metals. The method is based on the preparation and use of ion sieves. The invention makes it possible to improve the selectivity and exchange capacity for lithium on sorbents based on niobium oxide and improve the chemical stability of such sorbents in cyclic operations.

More specifically, the method of the invention is aimed at manufacturing an inorganic ion-exchanger in the form of solid particles, which constitute a chemical non-stoichiometric compound in the form of an inorganic polymeric aqua-oxo-hydroxo complex intended for selective extraction of lithium from lithium-containing natural and industrial brines, the inorganic ion-exchanger being represented by the following general formula:

HₐNbO_{(2.5+0.5-a)}·bLi₂O·cFe₂O₃·dH₂O;

wherein:
“a” is a number ranging from 0.5 to 2.0,
“b” is a number ranging from 0.01 to 0.4,
“c” is a number ranging from 0.05 to 0.11, and
“d” is a number ranging from 0.1 to 2.0.

The method consists of the following steps:
carrying out a process of coprecipitation by interacting at least one soluble niobium(V) compound with an acid solution of at least one iron(III) compound, thus forming a precipitate of a mixed niobium(V) and iron(III) hydrated oxide, which forms a suspension in a mother solution, the mother solution comprising a solution of salts resulting from the aforementioned interaction and constituting an electrolyte;
washing the obtained mixed niobium(V) and iron(III) hydrated oxide by decanting for removing an excess of the electrolyte;
granulating the mixed niobium(V) and iron(III) hydrated oxide by freezing thereof with subsequent defreezing, thus obtaining a granulated mixed niobium(V) and iron(III) hydrated oxide;
converting the granulated mixed niobium(V) and iron(III) hydrated oxide into a lithium form by treating thereof with a lithium-containing compound selected from the group consisting of aqueous solutions of lithium hydroxide (LiOH) and lithium carbonate (Li₂CO₃);
calcining the lithium form of the granulated mixed niobium(V) and iron(III) hydrated oxide to obtain a mixed tripled lithium, niobium(V), and iron(III) oxide in a granulated form, which constitutes a lithium-form of an inorganic ion-exchanger; and converting the lithium-form of the inorganic ion-exchanger into an H-form of the inorganic ion-exchanger by treating thereof with an acid solution selected from the group consisting of a nitric acid (HNO₃), a hydrochloric acid (HCl), a sulfuric acid (H₂SO₄) a perchloric acid (HClO₄), and a trichloroacetic acid (CCl₃COOH).

The aforementioned freezing is carried out for 24 to 48 hours at a temperature in a range of −4° C. to −10° C.

Calcining is performed preferably at a temperature in the range of 360° C. to 460° C.

In this invention, the use of niobium is based on the fact that, among other elements, niobium has one of the lowest neutrons capture cross sections, so it is, to a lesser degree, subject to the occurrence of induced radiation when exposed to neutron fluxes.

The term “brines,” as used in this patent specification, covers any natural or industrial solution that contains lithium. Ionic sieves mentioned in the specification are inorganic ion-exchange sorbents that exhibit the so-called ion-sieve effect resulting from separating ions that are contained in a solution according to the difference in their ionic radii. The sizes of crystallographic positions in the material's crystal structure correspond to ions of specific dimensions so that larger ions cannot enter the indicated positions. Thus, the ion-sieve effect ensures high selectivity in sieve-effect sorbents.

According to the present invention, a unique feature of the method is the addition of Fe³⁺ ions to the sorbent composition; this method allows obtaining inorganic ion-exchange sorbents with a specific structure, which provides high selectivity, especially for lithium ions.

It is also important to note that in the context of the present description, the term “mixed niobium and iron hydrated oxides” does not mean a mechanical mixture of hydrated niobium oxide with hydrated iron oxide but rather means a chemical compound of a non-stoichiometric composition.

Soluble niobium compounds for use in the method of the present invention are alkali metal orthoniobates selected from the group consisting of such compounds as Li₃NbO₄, Na₃NbO₄, K₃NbO₄, Rb₃NbO₄, Cs₃NbO₄, and niobium halides selected from the group consisting of such compounds as NbCl₅, NbOCl₃, NbBr₅, and NbOBr₃.

Soluble iron(III) compounds suitable for use in the method of the present invention may be represented by FeCl₃, FeBr₃, Fe(NO₃)₃, Fe₂(SO₄)₃, and Fe(CH₃COO)₃.

Examples of H-form sorbents suitable for use in the method of the invention are shown below in Table 1 (Li-forms are similar and therefore not included).

As disclosed in U.S. Pat. No. 10,434,497, a hydrated niobium pentoxide (HNP) can be obtained by using 0.1 N HCl on a solution of potassium orthoniobate K₃NbO₄ at pH=5.5. In the present invention, Fe³⁺ ion dopants were introduced into the hydrochloric acid solution by adding a calculated amount of salt FeCl₃. When using niobium halides, Fe³⁺ ions are introduced into a solution of a corresponding niobium halide.

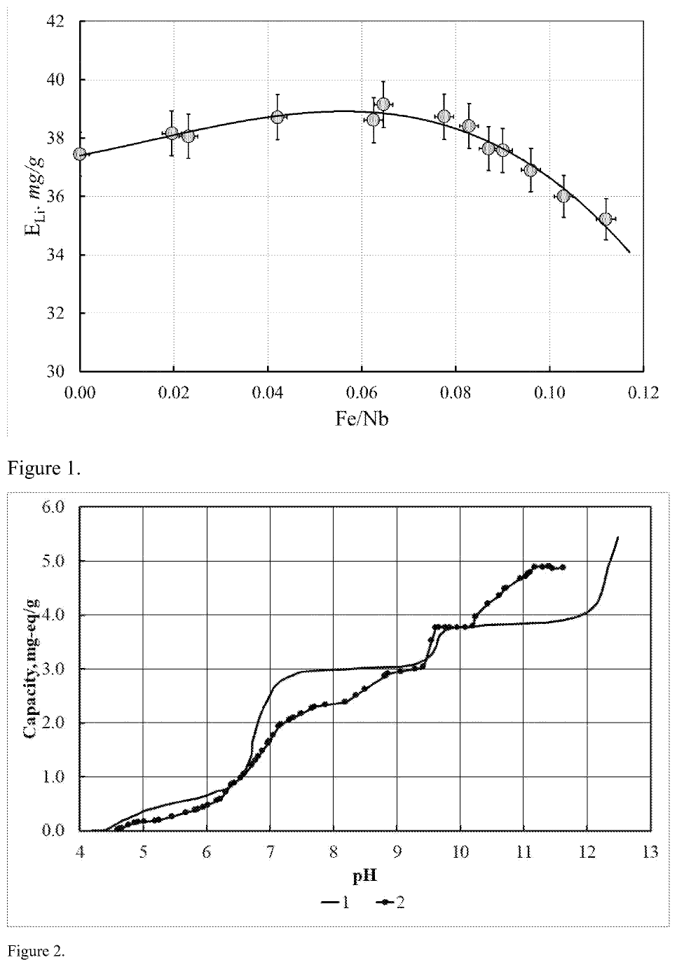

The co-precipitation method was used for introducing additives of Fe³⁺ ions into the phase of hydrated oxides. In this regard, the ion-exchange properties of the products of the co-precipitation of hydrated niobium pentoxide with Fe³⁺ ions were studied. The results of the study are shown in FIG. 1.

FIG. 1 shows the results of studying the properties of co-precipitation products of hydrated niobium pentoxide with the addition of Fe³⁺ ions. The dependence of hydrated niobium pentoxide properties as total exchange on the amount of the added Fe³⁺ was studied in a wide range of compositions (sorption of lithium from 0.1 N Li₂CO₃ solution; Fe/Nb is a molar ratio of the Fe³⁺ additive to the total amount of the Nb⁵⁺ ions in the sorbent composition.

As mentioned above, the obtained dependencies show that Fe³⁺ ions affect the ion-exchange properties of hydrated niobium pentoxide.

It was discovered that in the entire studied range of compositions (FIG. 1) the introduction of additives of Fe³⁺ ions into the hydrated niobium pentoxide structure led to a monotonic increase in the cation exchange capacity. A charge balance disorder can partially explain this effect since the charge of Fe³⁺ is less than that of Nb⁵⁺. It can also be assumed that such an effect results from structural changes caused in the Nb⁵⁺-containing hydrated niobium pentoxide by the introduction of Fe³⁺.

The added Fe³⁺ ions should affect the value of the cation-exchange capacity and the acidity of exchangeable OH-groups due to differences in the physical properties of Nb⁵⁺ ions and the added ions Fe³⁺. To clarify the extent of this effect, the inventors herein performed potentiometric titration of two hydrated niobium pentoxide samples by adding Fe³⁺ ions. Results of this test are shown in FIG. 2. The curves shown in this drawing illustrate the effect of pH of the sorbent solution on the total exchange capacity (E_{Li}, mg-eqv of Li per 1 g of sorbent) of a hydrated niobium pentoxide obtained in the titration of a hydrated niobium pentoxide sample without addition and with the addition of Fe³⁺ in a ratio of Fe(III):Nb(V)=0.07, the titration being carried out with 0.1N solution of LiOH (ionic strength I=0.1).

At the same time, it was found that the potentiometric titration curves of the samples exhibit effects like those exhibited by analogous dependence for the initial HNP.

This dependence (Curve 1) was obtained by potentiometric titration of a sample of ion-exchange material with 0.1 N LiOH solution (I=0.1). The following products were used as samples: 1—HNP without a dopant; 2—HNP with the addition of Fe³⁺ in a ratio of Fe(III):Nb(V)=0.07 (FIG. 2).

Comparison of the obtained dependences reveal that the most acidic sorption OH-groups remained almost unchanged. Still, their number increased, but the weakly acidic groups were partially acidified (Table 1).

TABLE 1
Acidity of exchangeable OH-groups (pKₐ) in the initial
HNP and in HNP with an additive of Fe³⁺ ions

| | | HNP with Addition of Fe³⁺ |
|---|---|---|
| | Initial | cations in a a Fe(III):Nb(V) |
| Type of Sorption Centers | HNP | ratio equal to 0.062 |
| 1 | 5.7 ± 0.5 | 6.0 ± 0.25 |
| 2 | 6.7 ± 0.5 | 6.6 ± 0.5 |
| 3 | 10.3 ± 0.2 | 9.1 ± 0.5 |
| 4 | 11.6 ± 0.4 | — |

Based on the data presented for the cation exchanger with the addition of Fe³⁺ ions, one can make some assumptions about the nature of their entry into the solid phase of the material. With small additions of Fe³⁺ ions (Fe(III):Nb(V) equal to 0.07), the behavior of the presented dependence indicates to replacement of Nb⁵⁺ ions by Fe³⁺ ions a close to isomorphic. At large amounts, Fe³⁺ ions seem to interact with the ion-exchange centers of HNP.

Thus, it can be noted that HNP co-precipitation products doped with Fe³⁺ ions have good ion-exchange properties. Changing the pH of the solution makes it relatively easy to control the amount of alkali metal ions introduced into their composition, guided by potentiometric titration curves. The tests were conducted in compliance with the potentiometric titration tests. In this way, three-component oxides of various designs can be obtained.

The observed acidification of OH groups upon the introduction of Fe³⁺ ions into the HNP phase results from the higher electronegativity of iron compared to the electronegativity of niobium. [See: Mulliken P. S. A new electroaffinity scale, together with data on valence states and on valence ionization potentials and electron affinities.—J. Chem. Phys., 1934, vol. 2, p. 782-793.].

Samples selected for the study were prepared by sorption of lithium from a 0.1 N solution of Li₂CO₃ on the H-form of an ion exchanger prepared with the addition of *Fe³⁺ ions. The lithium content in the solid phase was equal to the total exchange capacity of the related materials (FIG. 1). Optimal heat treatment, calcining, was carried out at a temperature of 430±30° C. for 2÷3 hours. All samples with different amounts of the additive were calcined simultaneously. Changing calcination duration, a selected time interval of 2 to 3 hours, had practically no effect on the ion-exchange properties of the obtained samples.

The performed X-ray phase analysis showed that calcining of the studied samples at a temperature exceeding the temperature of exothermic effects leads to the crystallization of the LiNbO₃ phase. Moreover, the nature of the X-ray patterns does not depend on how the crystallization proceeded. The X-ray phase analysis of samples calcined at a temperature corresponding to the optimal conditions for the synthesis of cation exchangers selective to Li⁺ ions showed that all samples contain the LiNbO₃ phase and some amount of the amorphous phase.

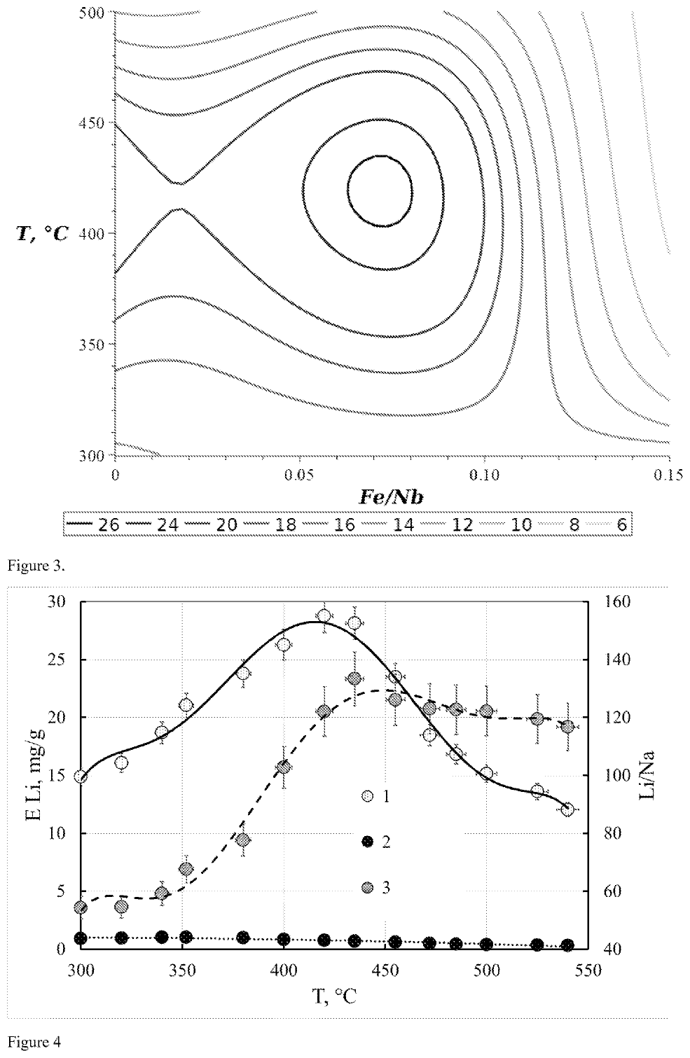

When studying the ion-exchange properties of the products of thermal treatment of HNP salt forms with the addition of various ions, the following characteristics of the aforementioned products were considered: their Li⁺ capacity (FIG. 3, 4, 5), Na⁺ capacity (FIG. 4, 5), the Li⁺/Na⁺ ratio in the exchanger phase (FIG. 4, 5), as well as chemical stability in sorption-desorption operation cycles (FIG. 6), during sorption from a solution of complex composition (Li/Na=1/10).

When studying the additive effect of Fe³⁺ ions on the properties of HNP, several samples were tested at different calcination temperatures, i.e., at 300° C. to 500° C. and separately at 540° C. The samples were tested at different temperatures to select an optimal range of calcination temperatures. The study was also aimed at comparing data obtained in the test of the method of the invention HNP (Li) with addition of Fe³⁺ with those disclosed in our previous patents and patent for pure HNP (Li).

Comparing the number of ions involved in the exchange in samples calcined at 400° C. with a total lithium content in the solid phase (FIG. 1), one can notice an almost complete absence of non-exchangeable lithium, up to the addition of Fe³⁺ in an amount exceeding the Fe/Nb>0.07 ratio. At the same time, no crystallization of the LiNbO₃ phase is observed in these samples. This effect can be related to the difficulty in the crystallization process of the LiNbO₃ phase at small amounts of addition of Fe³⁺ ions. A further decrease in the exchange capacity of the material is associated with the appearance of a well-crystallized lithium niobate phase.

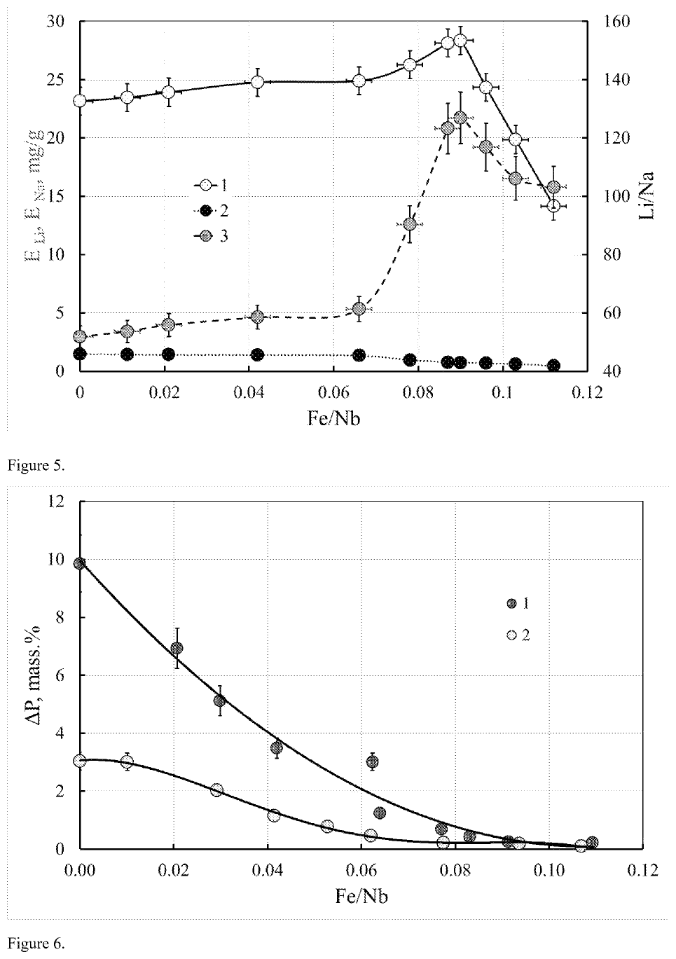

To study the selectivity of the synthesized materials to Li⁺ ions, experiments Were carried out on the sorption of lithium from solutions of complex compositions. Experiments have shown (FIG. 3-5) that the samples calcined at 400° C. were less selective to Li⁺ ions up to the addition of Fe³⁺ in the amount of Fe/Nb<0.07, compared with the samples calcined at temperatures above 500° C., although they have a high capacity for target ions.

The addition of iron ions also affects the chemical stability of the obtained materials, which leads to a significant decrease in the losses of the sorbent during its multicycle use (FIG. 6). In addition, the losses of samples calcined at 540° C. turned out to be three to four times lower than in the samples calcined at 400° C.

The invention will be further illustrated by practical examples that should not be considered as limiting the scope of application of the present invention.

### EXAMPLES

### Example 1

At vigorous stirring, two liters of 0.05 M solution of K₃NbO₄ (pH=12.7) is combined with a predetermined amount of 0.05 M solution of FeCl₃ in 1 M HCl. Precipitation is adjusted with HCl to maintain pH in the range of 5 to 6. The resulting precipitate is washed by successive decantation to a residual concentration of potassium ions equal to 0.08-0.09 g/l and frozen for ≈30 hours at a temperature ranging from −4 TC to −10° C. After thawing, the granulate is placed in an ion exchange column, and 4.5 liters of 0.1 M Li₂CO₃ solution are passed through the resulting precipitate. The precipitate is then unloaded from the column, dried in the air, heated to a temperature of 400 to-460° C. (at a temperature rise rate of 10° C. deg/min), and is maintained at this temperature for 3 hours. As a result, a sorbent is obtained in a Li-form, the main fraction of which is granules with a size of 0.2 to 0.8 mm.

The effects of operations conditions used for obtaining an ion exchanger on the sorption properties and purity of the resulting lithium salts are summarized in Table. 2. When testing the ion exchanger, solutions of the following compositions (g/l) were used: Li₂SO₄-5.5; NaCl, 56.0; NaOH, 3.0; pH 12.1. Lithium was desorbed from the sorbent with a 0.1 M HNO₃ solution.

Examples of sorbents of various compositions obtained by the proposed method in the H-form are given below in Table 2 (Li-forms are similar and, therefore, not included).

TABLE 2
Effects of operations conditions obtained for an ion exchanger on sorption properties.

| | | Test results | | | |
|---|---|---|---|---|---|
| Operation conditions | | | Selective | | Sorbent |
| Nb(V):Fe(III) | Thermal | | capacity | Separation | loss per |
| ratio in solution | treatment | Sorbent | for lithium, | coefficient, | operation |
| during synthesis | temperature ° C. | composition * | mg-eqv/g | P_{Li, Na} | cycle, [symbol] |
| 1:0.03 | 380 | H_{1.46}NbO_{3.23}•0.015Fe₂O₃ | 3.8 | 34.8 | 5.0 |
| 1:0.03 | 480 | H_{0.86}NbO_{2.93}•0.015Fe₂O₃ | 2.3 | 100.8 | 2.8 |
| 1:0.14 | 380 | H_{0.72}NbO_{2.86}•0.070Fe₂O₃ | 1.5 | 27.5 | 0.2 |
| 1:0.14 | 480 | H_{0.27}NbO_{2.64}•0.070Fe₂O₃ | 0.8 | 64.2 | 0.2 |
| 1:0.05 | 460 | H_{0.98}NbO_{2.99}•0.025Fe₂O₃ | 2.6 | 78.8 | 0.3 |
| 1:0.11 | 400 | H_{0.40}NbO_{2.70}•0.055Fe₂O₃ | 2.4 | 110.0 | 0.3 |
| 1:0.11 | 460 | H_{0.75}NbO_{2.88}•0.055Fe₂O₃ | 1.5 | 82.5 | 0.2 |
| 1:0.18 | 430 | H_{0.93}NbO_{2.97}•0.040Fe₂O₃ | 3.2 | 97.2 | 0.5 |
| 1:0.01 | 300 | H_{1.45}NbO_{3.25}•0.010Fe₂O₃ | 2.2 | 22.3 | 5.2 |
| 1:0.005 | 340 | H_{1.45}NbO_{3.25}•0.005Fe₂O₃ | 2.7 | 31.5 | 4.8 |
| 1:0.15 | 500 | H_{0.98}NbO_{3.01}•0.15Fe₂O₃ | 1.2 | 71.8 | 0.2 |
| 1:0.20 | 540 | H_{0.71}NbO_{2.84}•0.20Fe₂O₃ | 1.0 | 62.7 | 0.1 |

* Composition of sorbent prepared for sorption of lithium, H-form [symbol]
indicates data missing or illegible when filed

The test data for sorbent samples of various compositions given in the above table and shown in FIG. 8 confirm that the Fe/Nb ratio optimal for the sorbent synthesis i& in the range from 0.03 to 0.10. An optimal synthesis temperature is in the range of 360 to 460° C.

The advantages of the sorbents obtained by the method of the invention under the optimal conditions over the prototypes obtained by conventional methods can be seen from the results of comparative tests shown in Table 3. The tests were carried out using solutions of the compositions mentioned above. The table shows average results for 5 cycles of sorbent operations.

TABLE 3
Comparison of properties obtained in the sorbents
prepared by the method of the invention with
those obtained by conventional methods.

| | | |
|---|---|---|
| Sorption capacity, | Separation | Loss per |
| mg/g | coefficient, | cycle, |

| Sorbent | Lithium | Sodium | P_{Li, Na} | macc. % |
|---|---|---|---|---|
| Known | 16.0 | 0.54 | 86.7 | 2.0 |
| Proposed | 27.5 | 0.37 | 100.8 | 0.3 |

As can be seen from Table 3, the sorbent obtained by the method of the invention demonstrates higher selectivity and capacity for lithium ions than the sorbent synthesized by the known method. This makes it possible to reduce the content of the NaNO₃ impurity in the obtained lithium salt almost with a factor of 2. Also, the sorbent obtained by the method of the invention has a higher chemical resistance in the cycles of sorption and desorption, which makes it possible to increase the efficiency of its practical use.

The invention was described with reference to specific examples. It should be understood, however, that these examples should not be construed as limiting the scope of the practical application of the invention and that any changes and modifications are possible without departure from the scope of the attached patent claims. In particular, other practical examples may be derived from the graphs presented in the attached FIGS. 1 to 6.

1. A method of manufacturing an inorganic ion exchanger for selective extraction of lithium from lithium-containing natural and technological brines, the inorganic ion exchanger being represented by the following general formula:
HₐNbO_{(2.5+0.5-a)}·bLi₂O·cFe₂O₃·dH₂O;
wherein:
“a” is a number ranging from 0.5 to 2.0,
“b” is a number ranging from 0.01 to 0.4,
“c” is a number ranging from 0.05 to 0.11, and
“d” is a number ranging from 0.1 to 2.0, wherein the method comprising:
carrying out a process of coprecipitation by interacting at least one soluble niobium(V) compound with an acid solution of at least one iron(III) compound, thus forming a precipitate of a mixed niobium(V) and iron(III) hydrated oxide, which forms a suspension in a mother solution, the mother solution comprising a solution of salts resulting from the aforementioned interaction and constituting an electrolyte;
washing the obtained mixed niobium(V) and iron(III) hydrated oxide by decanting for removing an excess of the electrolyte;
granulating the mixed niobium(V) and iron(III) hydrated oxide by freezing thereof with subsequent defreezing, thus obtaining a granulated mixed niobium(V) and iron(III) hydrated oxide;
converting the granulated mixed niobium(V) and iron(III) hydrated oxide into a lithium form by treating thereof with a lithium-containing compound selected from the group consisting of aqueous solutions of lithium hydroxide (LiOH) and lithium carbonate (Li₂CO₃);
calcining the lithium form of the granulated mixed niobium(V) and iron(III) hydrated oxide to obtain a mixed tripled lithium, niobium(V), and iron(III) oxide in a granulated form, which constitutes a lithium-form of an inorganic ion-exchanger; and
converting the lithium-form of the inorganic ion-exchanger into an H-form of the inorganic ion-exchanger by treating thereof with an acid solution selected from the group consisting of a nitric acid (HNO₃), a hydrochloric acid (HCl), a sulfuric acid (H₂SO₄) a perchloric acid (HClO₄), and a trichloroacetic acid (CCl₃COOH).

2. The method of claim 1, wherein the inorganic ion-exchanger comprises solid particles, which constitute a chemical non-stoichiometric compound in the form of an inorganic polymeric aqua-oxo-hydroxo complex.

3. The method of claim 1, wherein the polymeric aqua-oxo-hydroxo complex is a polymeric aqua-oxo-hydroxo complex of niobium and iron.

4. The method of claim 1, wherein the soluble niobium compounds are alkali metal orthoniobates selected from the group consisting of Li₃NbO₄, Na₃NbO₄, K₃NbO₄, Rb₃NbO₄, Cs₃NbO₄, and niobium halides selected from the group consisting of NbCl₅, NbOCl₃, NbBr₅, and NbOBr₃.

5. The method of claim 2, wherein the soluble niobium compounds are alkali metal orthoniobates selected from the group consisting of Li₃NbO₄, Na₃NbO₄, K₃NbO₄, Rb₃NbO₄, Cs₃NbO₄, and niobium halides selected from the group consisting of NbCl₅, NbOCl₃, NbBr₅, and NbOBr₃.

6. The method of claim 3, wherein the soluble niobium compounds are alkali metal orthoniobates selected from the group consisting of Li₃NbO₄, Na₃NbO₄, K₃NbO₄, Rb₃NbO₄, Cs₃NbO₄, and niobium halides selected from the group consisting of NbCl₅, NbOC₃, NbBr₅, and NbOBr₃.

7. The method of claim 1, wherein the soluble iron(III) compounds are represented by compounds selected from the group consisting of FeCl₃, FeBr₃, Fe(NO₃)₃, Fe₂(SO₄)₃, Fe(CH₃COO)₃.

8. The method of claim 2, wherein the soluble iron(III) compounds are represented by compounds selected from the group consisting of FeCl₃, FeBr₃, Fe(NO₃)₃, Fe₂(SO₄)₃, Fe(CH₃COO)₃.

9. The method of claim 3, wherein the soluble iron(III) compounds are represented by compounds selected from the group consisting of FeCl₃, FeBr₃, Fe(NO₃)₃, Fe₂(SO₄)₃, Fe(CH₃COO)₃.

10. The method of claim 4, wherein the soluble iron(III) compounds are represented by compounds selected from the group consisting of FeCl₃, FeBr₃, Fe(NO₃)₃, Fe₂(SO₄)₃, Fe(CH₃COO)₃.

11. The method of claim 1, wherein freezing is carried out for 24 to 48 hours at a temperature range of −4° C. to −10° C.

12. The method of claim 2, wherein freezing is carried out for 24 to 48 hours at a temperature range of −4° C. to −10° C.

13. The method of claim 3, wherein freezing is carried out for 24 to 48 hours at a temperature range of −4° C. to −10° C.

14. The method of claim 4, wherein freezing is carried out for 24 to 48 hours at a temperature range of −4° C. to −10° C.

15. The method of claim 5, wherein freezing is carried out for 24 to 48 hours at a temperature range of −4° C. to −10° C.

16. The method of claim 2, wherein converting the granulated mixed hydrated niobium(V) and iron(III) oxide into a lithium form is carried out by treating thereof with a lithium-containing compound selected from the group consisting of aqueous solutions of lithium hydroxide (LiOH) and lithium carbonate (Li₂CO₃).

17. The method of claim 5, wherein converting the granulated mixed hydrated niobium(V) and iron(II) oxide into a lithium form is carried out by treating thereof with a lithium-containing compound selected from the group consisting of aqueous solutions of lithium hydroxide (LiOH) and lithium carbonate (Li₂CO₃).

18. The method of claim 6, wherein converting the granulated mixed hydrated niobium(V) and iron(III) oxide into a lithium form is carried out by treating thereof with a lithium-containing compound selected from the group consisting of aqueous solutions of lithium hydroxide (LiOH) and lithium carbonate (Li₂CO₃).

19. The method of claim 1, wherein calcining is carried out at a temperature in the range of 360° C. to 460° C. and freezing is carried out for 24 to 48 hours at a temperature range of −4° C. to −10° C.

20. The method of claim 18, wherein calcining is carried out at a temperature in the range of 360° C. to 460° C. and freezing is carried out for 24 to 48 hours at a temperature range of −4° C. to −10° C.
